(19) United States
(12) Patent Application Publication
(10) Pub. No.: US 2025/0040479 A1
(43) Pub. Date: Feb. 6, 2025

(54) ROTARY CUTTER FLEX WING TRANSPORT LOCK

(71) Applicant: Deere & Company, Moline, IL (US)

(72) Inventors: Kellen B. Hill, Ottumwa, IA (US); José Martín Domínguez Sánchez, Queretaro (MX)

(73) Assignee: Deere & Company, Moline, IL (US)

(21) Appl. No.: 18/776,490

(22) Filed: Jul. 18, 2024

Related U.S. Application Data
(60) Provisional application No. 63/516,692, filed on Jul. 31, 2023.

(51) Int. Cl. A01D 34/74; A01D 34/66

(52) U.S. Cl. CPC A01D 34/74; A01D 34/66

(57) ABSTRACT

One or more techniques and/or systems are disclosed for a locking system for a rotary cutter comprising a cutting deck comprising a center portion, a first wing, a second wing, a center deck support system pivotably engaged with the cutting deck, a mount, an actuator, and a bracket stop. The deck support system comprises a bracket and a wheel system operably engaged with a surface beneath the cutting deck. The mount is fixedly engaged to the center portion and comprises a guide. The actuator comprises a distal end slidably engaged with the guide, and a proximal end engaged with the bracket. The bracket stop limits the travel of the deck support system past a predetermined position and allows the distal end of the actuator to move to a shipping set point at the end of the guide whereby putting the first wing and the second wing in position for transport.

### CROSS-REFERENCE TO RELATED APPLICATION(S)

This application claims priority to U.S. Ser. No. 63/516,692, entitled ROTARY CUTTER LEVELING SYSTEM, filed Jul. 31, 2023, which is incorporated herein by reference BACKGROUND

An agricultural rotary cutter is a heavy-duty cutting machine used in farming and land clearing operations to mow down and clear dense vegetation, small trees, crops, and crop remnants in fields or pastures. A rotary cutter can be substantially wide to efficiently cut large swaths, and is typically equipped with sharp rotating blades, usually mounted on a spinning drum, which efficiently cuts through thick grass, shrubs, crop stalks, etc. The cutter's sturdy design allows it to handle rough and uneven terrain, providing effective vegetation control, land maintenance, and land clearing services in agricultural settings.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

One or more techniques and systems are described herein for locking the height of an agricultural rotary cutter relative to a surface beneath the rotary cutter to enable a narrow, secure configuration of the rotary cutter for transport.

In an implementation, a locking system may be implemented in a rotary cutter. The rotary cutter may comprise a cutting deck comprising a center portion, a first wing, and a second wing. The rotary cutter may further comprise a center deck support system, a mount, an actuator, and a bracket stop. The center deck support system may be pivotably engaged with the cutting deck and may comprise a bracket and a wheel system. The wheel system may be operably engaged with a surface beneath the cutting deck, and the deck support system may be configured to raise and lower the wheel system relative to the cutting deck. The mount may be fixedly engaged to the center portion and may comprise a guide. The actuator may comprise a distal end slidably engaged with the guide, and may further comprise a proximal end engaged with the bracket. The bracket stop may limit the travel of the deck support system past a predetermined position and may allow the distal end of the actuator to move to a shipping set point at the end of the guide whereby putting the first wing and the second wing in position for transport.

In another implementation, engaging the bracket stop with the bracket and adjusting the extension of the actuator may enable the distal end of the actuator to translate along a length of the guide.

In yet another implementation, the distal end of the actuator may translate along the length of the guide while the actuator is extended in a range of being fully retracted to an intermediate position between fully extended and fully retracted.

In a further implementation, adjusting the extension of the actuator may result in an adjustment to a height of the cutting deck relative to the surface while the actuator is extended in a range of being fully extended to the intermediate position.

In another implementation, disengaging the bracket stop from the bracket and adjusting the extension of the actuator may result in an adjustment to a height of the cutting deck relative to the surface.

In yet another implementation, the bracket stop may comprise a first portion and a second portion, and the first portion may be selectably engaged with the second portion.

In a further implementation, the first portion of the bracket stop may be telescopically engaged with the second portion.

In another implementation, the rotary cutter may further comprise a fastener sized and shaped to selectably engage the first portion of the body of the bracket stop with the second portion to limit the retraction of the second portion relative to the first portion.

In yet another implementation, the second portion of the bracket stop may be configured to pivot between a first unlocked position and a second locked position relative to the first portion such that the bracket and the second portion may be mitigated from rotation beyond the predetermined position when the second portion is in the second locked position.

In a further implementation, the proximal end of the actuator may be engaged with the bracket of the deck support system at a first height, and the bracket stop may be selectably engaged with the bracket at a second height, wherein the first height may be greater than the second height relative to the cutting deck.

In another implementation, the guide may be a slotted opening extending through the mount.

In yet another implementation, the guide may comprise a distal end and a proximal end, and may be angled such that the distal end of the guide may be at a height relative to the cutting deck greater than a height of the proximal end of the guide.

In a further implementation, the guide may be sized and shaped to be one of an arc, a slant, or substantially horizontal.

In another implementation, the rotary cutter may further comprise an actuator fastener sized and shaped to pivotably couple the distal end of the actuator to the guide such that the distal end of the actuator may be configured to translate along the length of the guide.

In yet another implementation, the deck support system may further comprise a fulcrum pivotably engaged with the cutting deck. The fulcrum may define an axis about which the deck support system may rotate.

In a further implementation, a wheel pivot system may be implemented in a rotary cutter. The rotary cutter may comprise a cutting deck comprising a center portion, a first wing, and a second wing. The rotary cutter may further comprise a center deck support system, a mount, an actuator, and a bracket stop. The center deck support system may comprise a fulcrum, a bracket, and a wheel system. The fulcrum may be coupled to the cutting deck and may define an axis about which the deck support system may rotate. The mount may be fixedly engaged to the center portion and may comprise a guide. The actuator may comprise a distal end that may operably engage the bracket of the deck support system such that an activation of the actuator may rotate the deck support system, and a proximal end that may be slidably engaged with the guide. The bracket stop may be configured to be operably adjustable between a first unlocked configuration and a second locked configuration. The second locked configuration may define a rotation limit of the deck support system. Adjusting the bracket stop to the second locked configuration and activating the actuator to rotate the deck support system may limit the travel of the deck support system past a predetermined position and may allow the distal end of the actuator to move to a wing retraction set point at the end of the guide, whereby the first wing and the second wing may be put in position for transport.

In another implementation, adjusting the extension of the actuator may result in an adjustment to the height of the cutting deck relative to a surface beneath the cutting deck while the actuator is extended in a range of being fully extended to the intermediate position, wherein the intermediate position may be about two-thirds extended.

In yet another implementation, a lower height of the cutting deck relative to a surface beneath the cutting deck while the bracket stop is in the second locked configuration may be determined based on a shorter length of the bracket stop in the second locked configuration.

In a further implementation, a locking system may be implemented in a rotary cutter. The rotary cutter may comprise a cutting deck comprising a center portion, a first wing, and a second wing. The center portion may further comprise a center deck support system, a mount, an actuator, and a bracket stop. The center deck support system may be pivotably engaged with the cutting deck and may comprise a bracket and a wheel system. The wheel system may be operably engaged with a surface beneath the cutting deck, and the deck support system may be configured to raise and lower the wheel system relative to the cutting deck. The mount may be fixedly engaged to the center portion and may comprise a guide. The actuator may comprise a distal end slidably engaged with the guide, and may further comprise a proximal end engaged with the bracket. The bracket stop may limit the travel of the deck support system past a predetermined position and may allow the distal end of the actuator to move to a wing retraction set point at the end of the guide whereby putting the first wing and the second wing in position for transport.

The first cutting wing may be pivotally coupled to the cutting deck and may comprise a first wing support system. The first wing support system may comprise a wheel system operably engaging with the surface. The first cutting wing may further comprise a first wing actuator, and the first wing actuator may be configured to operably engage the first wing support system to extend and retract the wheel system relative to the first cutting wing. The second cutting wing may be pivotally coupled to the cutting deck and may comprise a second wing support system that may comprise a wheel system that may operably engage with the surface. The second cutting wing may further comprise a second wing actuator, and the second wing actuator may be configured to operably engage the second wing support system to extend and retract the wheel system relative to the second cutting wing. The extension of the actuator of the cutting deck, the first wing actuator, and the second wing actuator may be configured to be adjusted simultaneously, and the first wing wheel system and second wing wheel system may be configured to continue pivoting to a position for transport when the deck support system is limited at the predetermined position.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

The examples disclosed herein may take physical form in certain parts and arrangement of parts, and will be described in detail in this specification and illustrated in the accompanying drawings which form a part hereof and wherein:

FIG. 1 is a component diagram illustrating a perspective view of a rotary cutter having a leveling system according to an implementation.

FIG. 2 is a component diagram illustrating a top view of a rotary cutter having a leveling system according to an implementation.

FIG. 3 is a component diagram illustrating a perspective view of a rotary cutter having a leveling system and a wing actuating system according to an implementation.

FIG. 4 is a component diagram illustrating a perspective view of a rotary cutter having a locking system according to an implementation.

FIG. 5 is a component diagram illustrating a perspective view of a locking system for a rotary cutter according to an implementation.

FIG. 6 is a component diagram illustrating a left side view of a locking system for a rotary cutter according to an implementation.

FIG. 7 is a component diagram illustrating a perspective view of a locking system for a rotary cutter according to an implementation.

FIG. 8 is a component diagram illustrating a rear perspective view of a center leveling sub-system of a rotary cutter having a leveling system according to an implementation.

FIG. 9 is a component diagram illustrating a front perspective view of a center leveling sub-system of a rotary cutter having a leveling system according to an implementation.

FIG. 10 is a component diagram illustrating rear perspective view of a first wing leveling sub-system of a rotary cutter having a leveling system according to an implementation.

FIG. 11 is a component diagram illustrating front perspective view of a first wing leveling sub-system of a rotary cutter having a leveling system according to an implementation.

FIG. 12 is a component diagram illustrating left side view of a first wing leveling sub-system of a rotary cutter having a leveling system according to an implementation.

FIG. 13 is a component diagram illustrating a rear perspective view of a second wing leveling sub-system of a rotary cutter having a leveling system according to an implementation.

FIG. 14 is a component diagram illustrating front perspective view of a second wing leveling sub-system of a rotary cutter having a leveling system according to an implementation.

FIG. 15 is a component diagram illustrating right side view of a second wing leveling sub-system of a rotary cutter having a leveling system according to an implementation.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

The methods and systems disclosed herein, for example, may be suitable for use in different rotary cutters and agricultural and agrarian applications requiring a particular clearance above the ground. That is, the herein disclosed examples can be implemented in different agricultural equipment other than for clearing particular types of grasses, crops, and/or other vegetation (e.g., other than for specific field clearing equipment for particular cutting applications, such as the herein described rotary cutter).

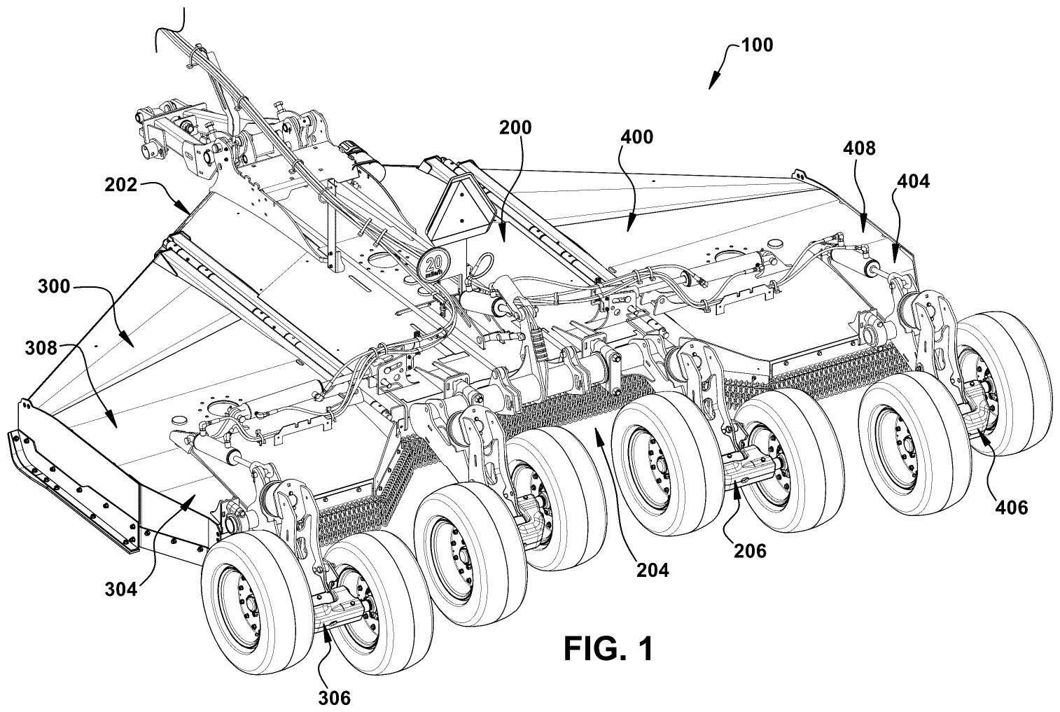

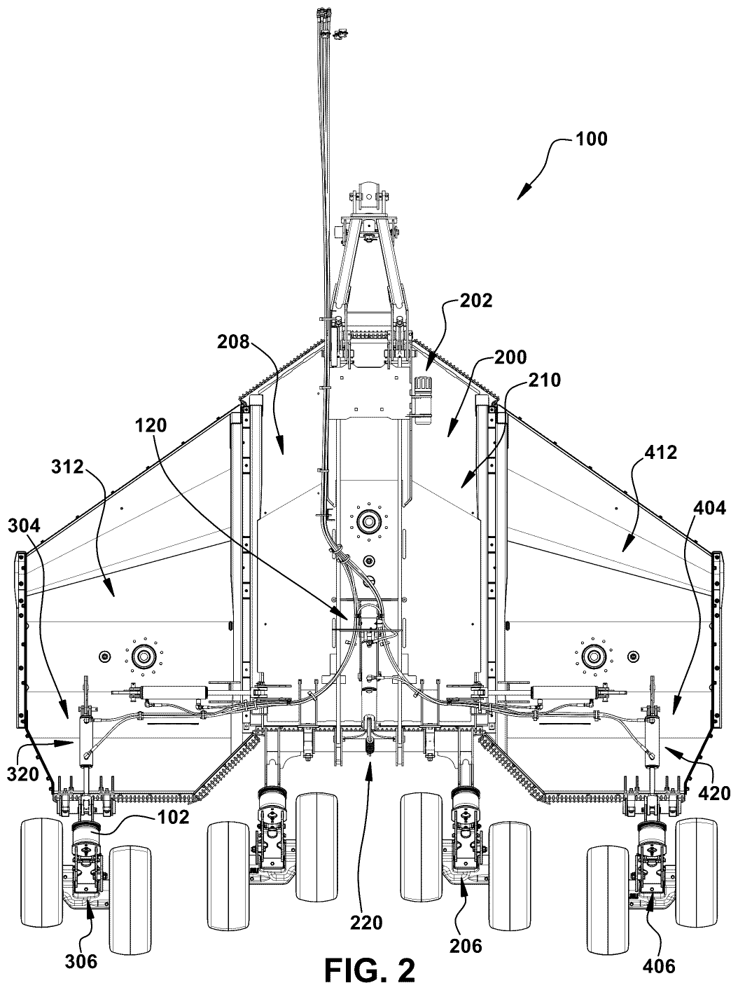

FIGS. 1-4 illustrate an example rotary cutter 100 that can utilize one or more portions of the aspects and examples described herein to level and lock a piece of equipment above a surface, such as the ground. In this example, the rotary cutter 100 is a flex wing rotary cutter, but other types of rotary cutters are contemplated by this disclosure.

The rotary cutter 100 includes a center portion 200 being a center cutting portion having a front end 202 configured to be mounted to a tractor or other mechanism having towing capabilities (not shown) and a back end 204 supported by at least one deck support system 206, such as a wheel system. The rotary cutter 100 also includes a first wing 300 being a first cutting wing pivotally coupled to a first side 208 of the center portion 200 and a second wing 400 being a second cutting wing pivotally coupled to a second end 210 of the center portion 200. The first wing 300 is supported by the center portion 200 on one side, and by a second deck support system 306 (e.g., a second wheel system) at a back end 304 of the first wing 300. The second wing 400 is supported by the center portion 200 on one side, and by a third deck support system 406 (e.g., a third wheel system) at a back end 404 of the second wing 400. It will be appreciated that the rotary cutter 100 may comprise any number of cutting wings and corresponding deck support system. For example, in one implementation, may comprise a center cutting portion, a first cutting wing pivotally coupled to the center cutting portion, a second cutting wing pivotally coupled to the center cutting portion, a third cutting wing pivotally coupled to the first cutting wing, and a fourth cutting wing pivotally coupled to the second cutting wing.

In certain implementations, each deck support system 206, 306, 406, 506 may include a suspension element 102 to provide dampening of the rotary cutter 100 as it passes through a field or other uneven surface. The dampening provides improved ride quality and operator comfort, increases the life of the rotary cutter, and enables a more consistent and level cut. In one implementation the suspension element 102 can comprise a foam urethane suspension element having a plurality of conjoined disks capable of compressing and reforming. It will be appreciated that the suspension element 102 may be any suitable suspension mechanism, for example, metallic springs, rubber springs, air suspension systems, etc.

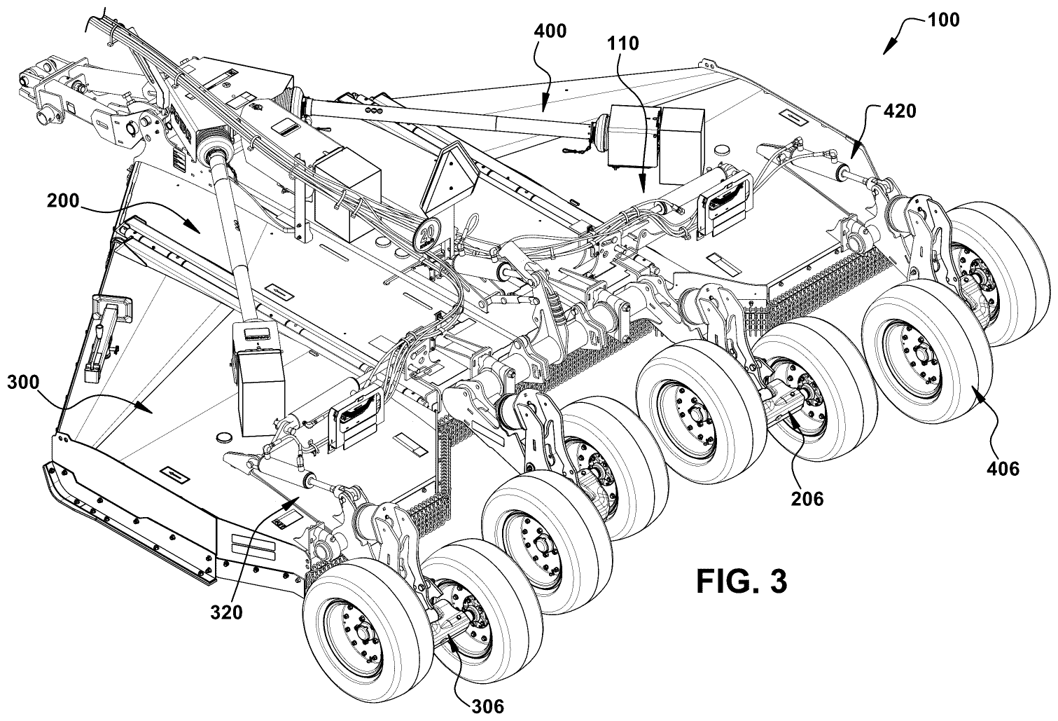

As shown in FIG. 3, the rotary cutter 100 is configured to utilize a wing actuating system 110 to operably pivot the first wing 300 and the second wing 400 between the first upright position and the second extended position. By enabling a first upright position and a second extended position, an operator of the rotary cutter 100 may easily transport the rotary cutter 100 in the more narrow, upright position while retaining the efficient cutting capabilities when in the wider, extended position. In the illustrated example, the wing actuating system 110 is a hydraulic piston system. It will be appreciated that the wing actuating system 110 may utilize any suitable actuators or piston types capable of pivoting the first wing 300 and the second wing 400 between a first upright position and a second extended position. For example, the wing actuating system 110 may alternatively be pneumatic, electrical, electromechanical, etc.

The rotary cutter 100 includes an actuator system 120 configured to operably adjust the height of the center portion 200, the first wing 300, and the second wing 400 between a first raised position and a second lowered position such that the first wing 300 and the second wing 400 move relative to the center portion 200. By enabling the center portion 200, first wing 300 and second wing 400 to be raised and lowered relative to a surface, such as the ground, a user is able to cut a field or pasture to a predetermined level. This predetermined level may be based on the wetness of a field or pasture, the thickness of the grass or crop or brush being cut, a desired aesthetic height, etc. In the illustrated example, the actuator system 120 is a hydraulic piston system. It will be appreciated that the actuator system 120 may utilize any suitable actuator or piston types capable of adjusting the height of the center portion 200, the first wing 300, and the second wing 400 between a first raised position and a second lowered position. For example, the actuator system 120 may alternatively be pneumatic, electrical, electromechanical, etc.

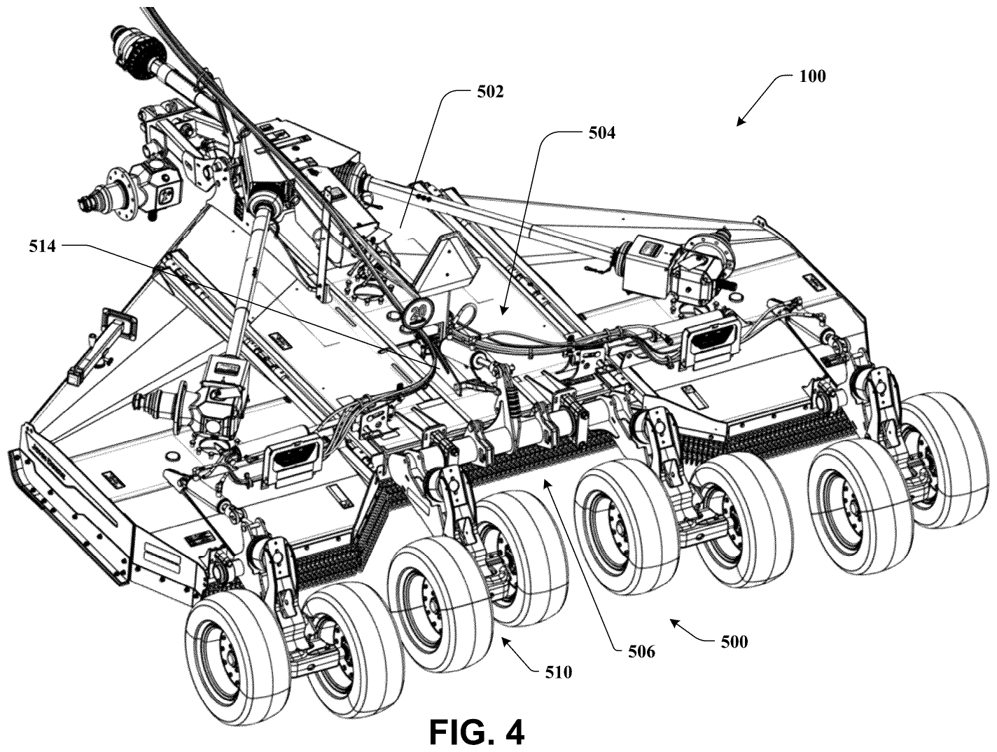

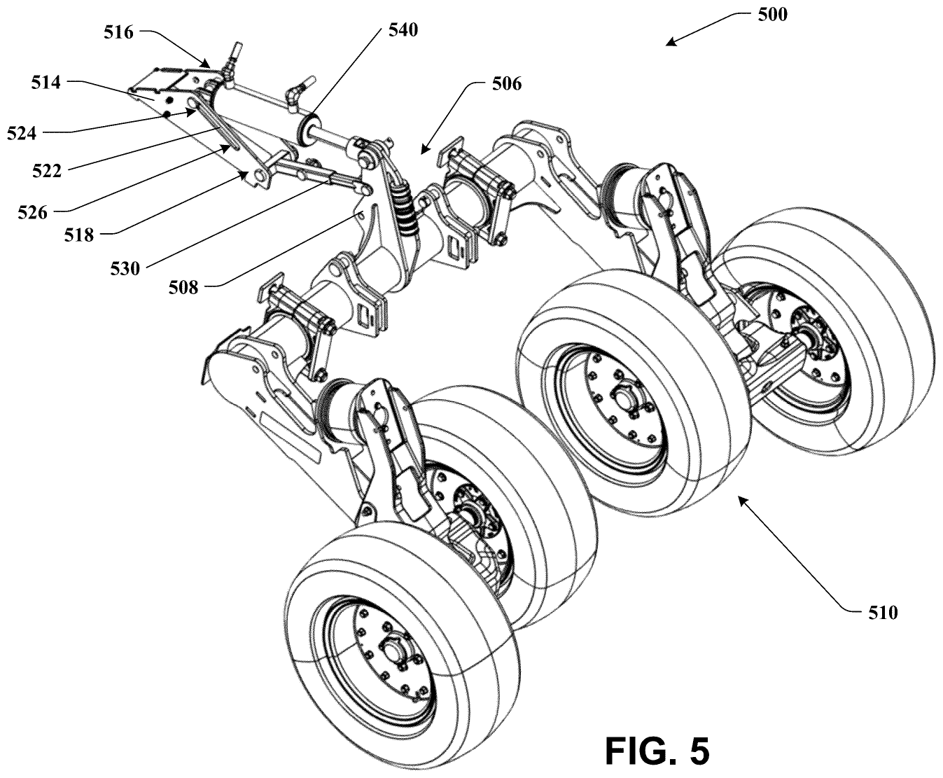

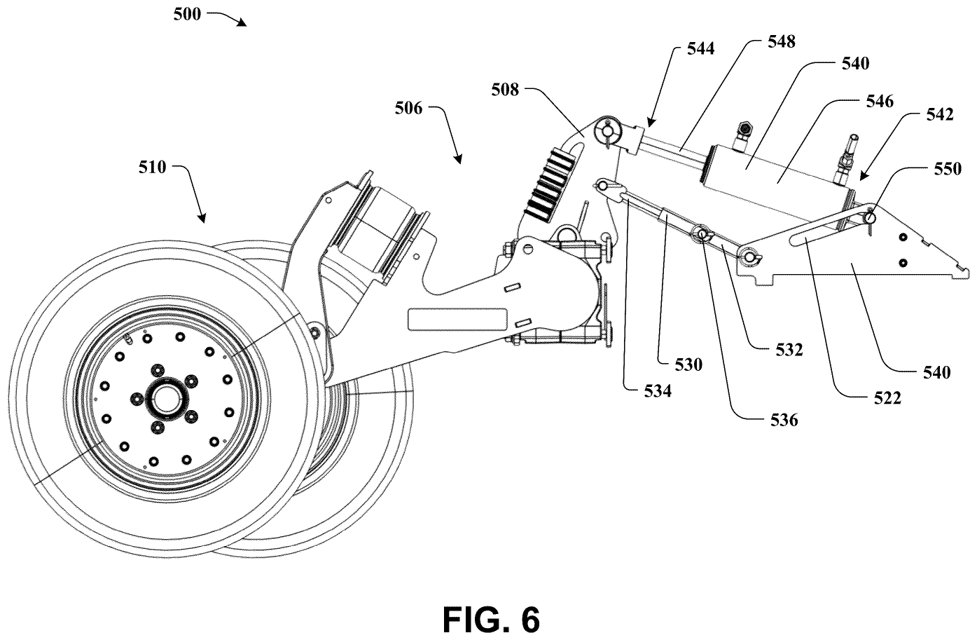

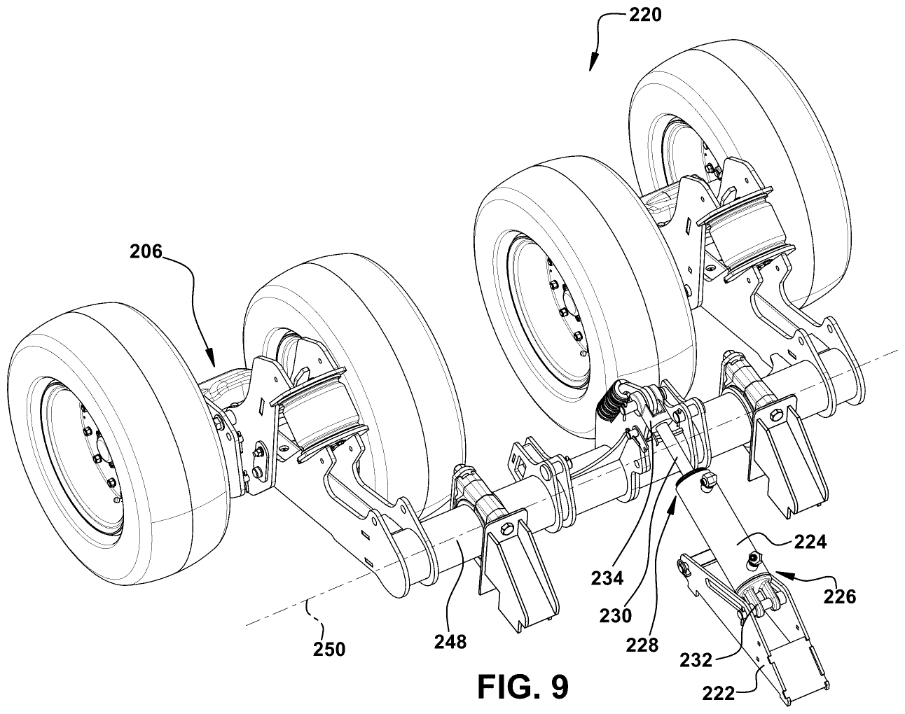

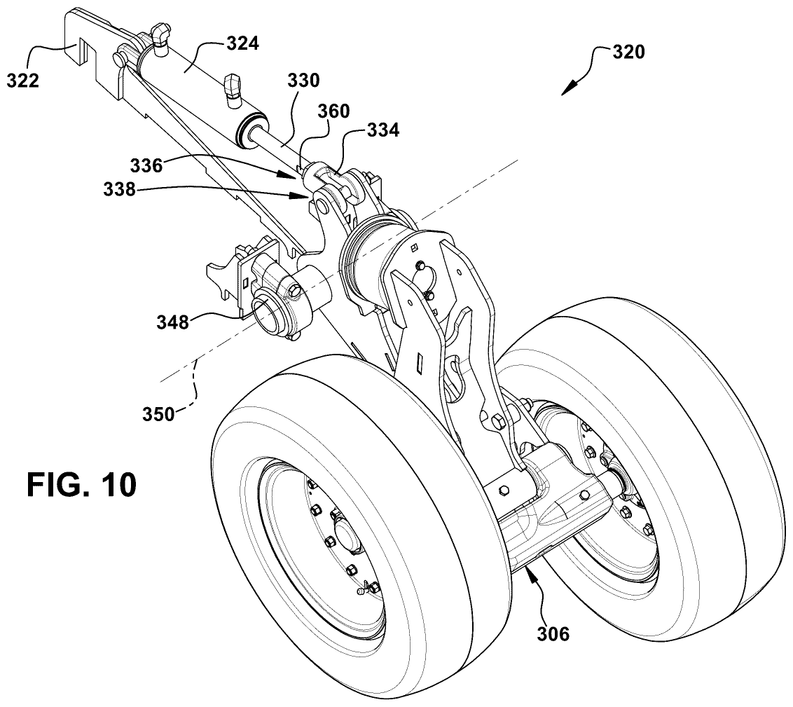

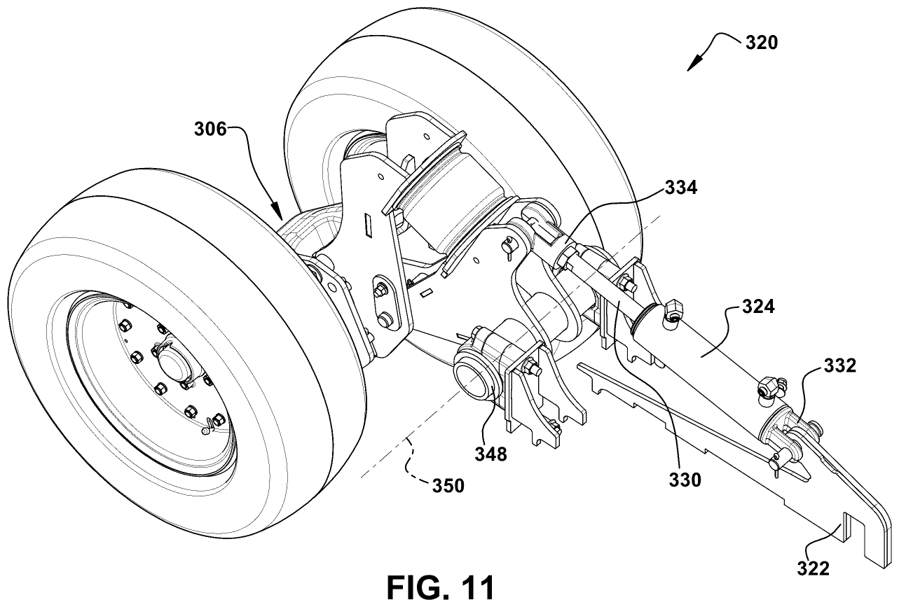

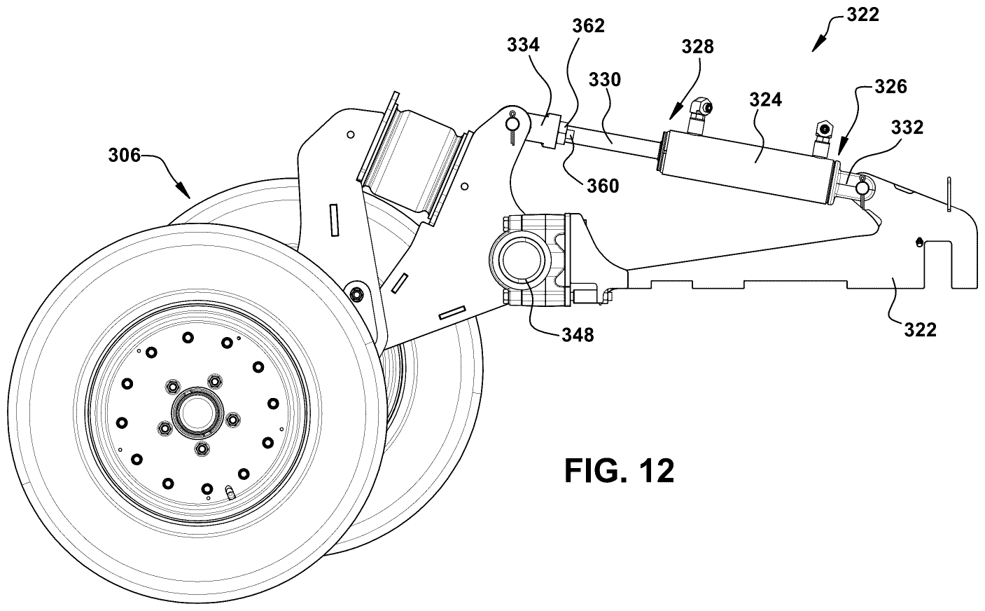

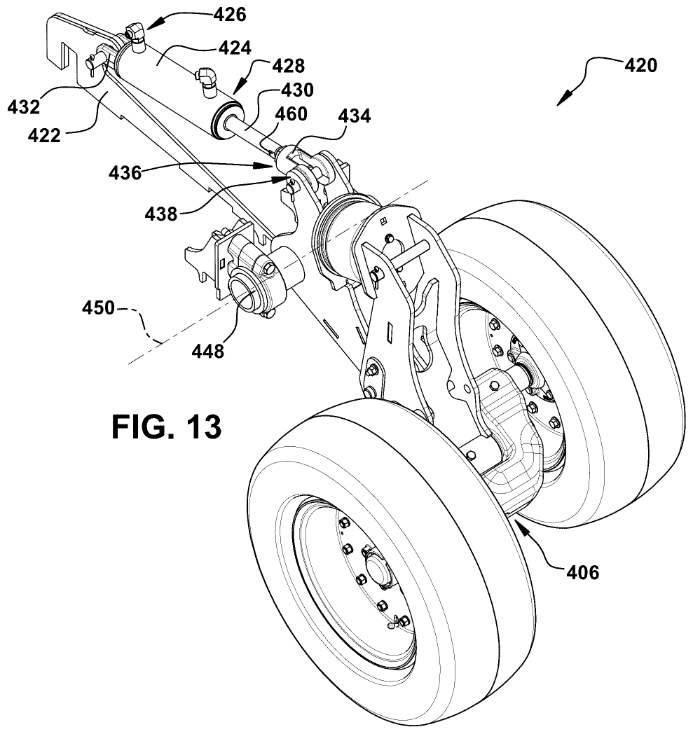

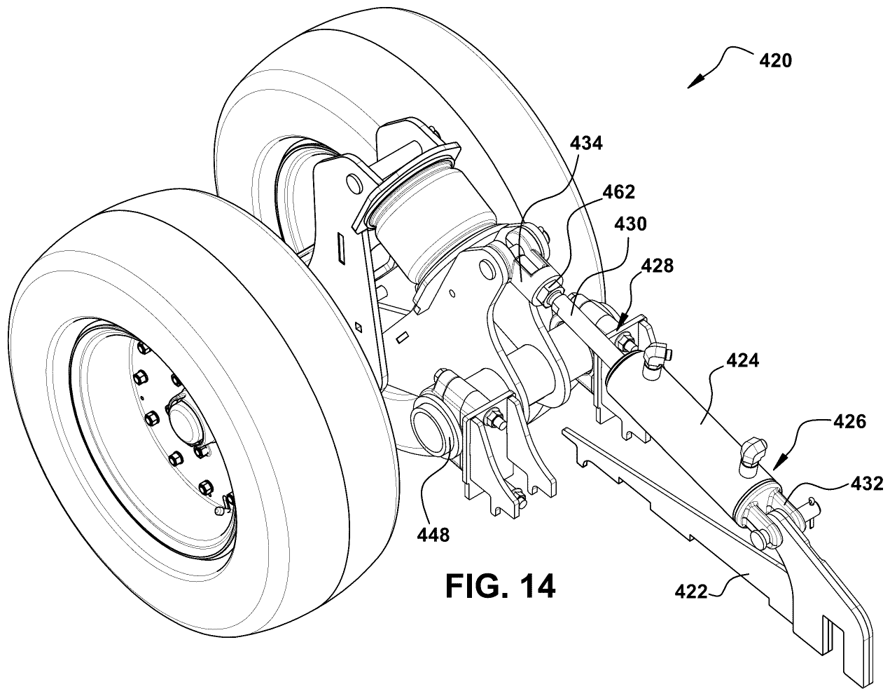

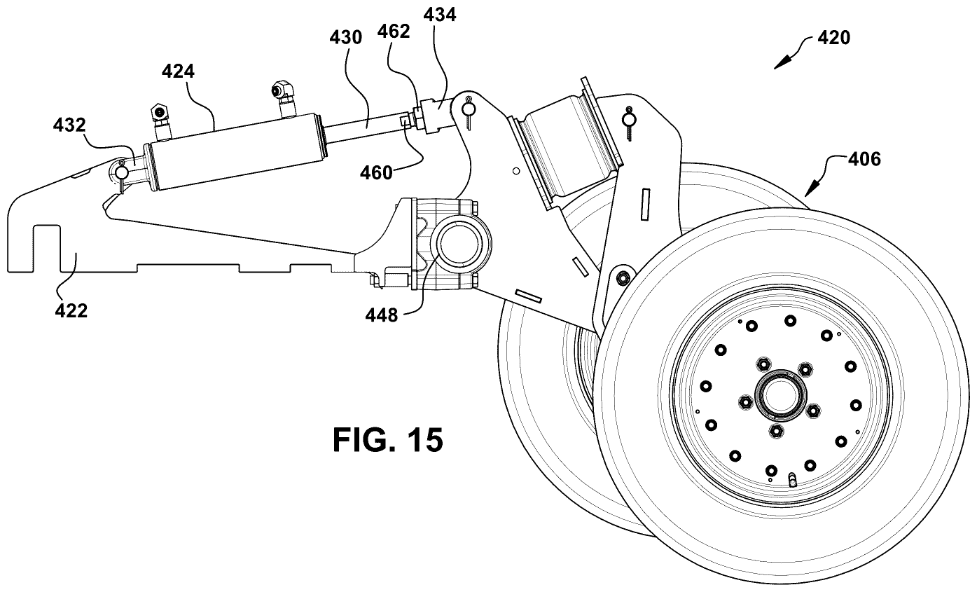

Turning now to FIGS. 4-15, the actuator system 120 will be described in detail herein. To adjust the height of the center portion 200, the first wing 300, and the second wing 400 between a first raised position and a second lowered position, the actuator system 120 includes a center leveling sub-system 220, a first wing leveling sub-system 320, and a second wing leveling sub-system 420 each connected to the respective deck support system 206, 306, 406, 506. The actuator system 120 is capable of simultaneously actuating each leveling sub-system 220, 320, 420 to engage the respective deck support system 206, 306, 406, 506 thereby adjusting the height of the first wing 300 and the second wing 400 relative to the center portion 200.

To effectuate the height adjustment of each of the center portion 200, first wing 300, and second wing 400, each of the leveling sub-systems 220, 320, 420 includes an actuator 224, 324, 424 having a first end 226, 326, 426 configured to be pivotally coupled to a mount 222, 322, 422, the mount being positioned proximate the back end 204, 304, 404 of the respective center portion 200, first wing 300, or second wing 400. In the illustrated example, each mount 222, 322, 422 is a single projecting member or a pair of spaced projecting members extending from the respective center portion 200, first wing 300, or second wing 400. It will be appreciated that each mount 222, 322, 422 may be any suitable shape capable of securing the actuator 224, 324, 424 to the respective center portion 200, first wing 300, or second wing 400.

To pivotally couple each actuator 224, 324, 424 to its respective mount 222, 322, 422, the first end 226, 326, 426 of each actuator 224, 324, 424 may comprise a pin style mount, such as using a pair of spaced projections 232, 332, 432 extending therefrom, the pair of spaced projections 232, 332, 432 having an opening extending therethrough. The openings of the pair of spaced projections 232, 332, 432 are aligned with an opening extending through the respective mount 222, 322, 422 such that a pin or rod may be inserted therethrough and secured in place (e.g., with a fastener, clip, pin, etc.). It will be appreciated that the actuator 224, 324, 424 of each leveling sub-system 220, 320, 420 may be pivotally coupled to the respective mount 222, 322, 422 by any suitable means, for example, a hinge system, pivot joints, etc. By pivotally coupling each actuator 224, 324, 424 to the respective mount 222, 322, 422, each actuator 224, 324, 424 is able to pivot to accommodate for the actuation of the respective leveling system 220, 320, 420.

Each actuator 224, 324, 424 further includes a second end 228, 328, 428 comprising a piston rod 230, 330, 430 configured to be selectably coupled to a respective clevis 234, 334, 434. In an implementation, the engagement end of each piston rod 230, 330, 430 is threaded (e.g., comprising external threading) and configured to be threadably coupled to the respective clevis 234, 334, 434, which comprises complementary threading configured to receive the threading of the piston rod 230, 330, 430 (e.g., comprising a via with internal, complementary threading).

Each clevis 234, 334, 434 has a first end 236, 336, 436 configured to receive the respective piston rod 230, 330, 430 and a second end 238, 338, 438 configured to be pivotally coupled to the respective deck support system 206, 306, 406, 506. It will be appreciated that each clevis 234, 334, 434 may be any suitable clevis type or shape capable of receiving a piston rod 230, 330, 430 and being pivotally coupled to a deck support system 206, 306, 406, 506 for example, a rod clevis, a hanger clevis, etc. In the illustrated example, each clevis 234, 334, 434 is a rod clevis including a base having a threaded (e.g., comprising internal threading) opening/via therethrough and a pair of spaced projections extending therefrom each having an opening. In the same example, the threaded opening is configured to threadably receive a respective piston rod 230, 330, 430 having complementary threading, and the openings of the spaced projections are configured such that a rod may be inserted therethrough and secured with a pin.

Upon actuating the actuator system 120, the actuator 224, 324, 424 of each leveling sub-system 220, 320, 420 simultaneously actuates causing each piston rod 230, 330, 430 to be extended from or withdrawn into its respective actuator 224, 324, 424, comprising a primary adjustment of the deck. The displacement of the piston rod 230, 330, 430 is translated to each clevis 234, 334, 434, thereby changing a distance between the first end 226, 326, 426 of the actuator 224, 324, 424 and the clevis 234, 334, 434 and displacing each deck support system 206, 306, 406, 506. In the illustrated example, the outward displacement of each piston rod 230, 330, 430 increases a distance between the first end 226, 326, 426 of the actuator 224, 324, 424 and the clevis 234, 334, 434 causing each deck support system 206, 306, 406, 506 to pivot clockwise about a fulcrum 248, 348, 448 defining an axis 250, 350, 450, thereby engaging a surface (e.g., ground) to raise each of the center portion 200, first wing 300 and second wing 400 relative to the surface. Inversely, the inward displacement of each piston rod 230, 330, 430 decreases a distance between the first end 226, 326, 426 of the actuator 224, 324, 424 and the clevis 234, 334, 434 causing each deck support system 206, 306, 406, 506 to pivot counterclockwise about a fulcrum 248, 348, 448 and lower each of the center portion 200, first wing 300 and second wing 400 relative to the surface.

Turning to FIGS. 3-7, an implementation of a rotary cutter 100 having a level locking system 500 is shown. Once the actuator system 120 is used to adjust a height of the center portion 200 and first and second cutting wings 300, 400, a locking system 500 may be used to at least prevent the center portion 200 of a cutting deck 502 of the rotary cutter 100 from being lowered relative to the surface beneath the cutting deck 502. In one implementation, a locking system 500 may be used to prevent a change of the height of the center portion 200 relative to the surface despite additional downward forces such as from the first and second cutting wings 300, 400 when the first and second cutting wings 300, 400 are in a first upright position for travel.

The locking system 500 for the rotary cutter 100 may comprise a cutting deck 502 comprising a center portion 200, a first wing 300, and second wing 400, a center deck support system 506 comprising a bracket 508 and a wheel system 510 configured to operably engage with a surface beneath the cutting deck 502, a mount 514 fixedly engaged with the center portion 200 and comprising a guide 522, an actuator 540 engaged with the mount 514 and the bracket 508, and a bracket stop 530 limiting the travel of the center deck support system 506 past a predetermined position. In one implementation shown in FIG. 4, the first wing 300 the second wing 400 may be capable of pivoting between a first upright position and a second extended position.

The mount 514 may be fixedly engaged to a top 504 of the cutting deck 502 and may comprise a distal end 516 and a proximal end 518 relative to the center deck support system 506, and may comprise a guide 522. In one implementation, the mount 514 may be substantially triangular in shape, the distal end 516 of the mount 514 being proximate a peak of the substantially triangular mount 514.

The guide 522 may be a slotted opening extending through the mount 514. In another implementation, the guide 522 may be a groove formed in the mount 514. The guide 522 may comprise a distal end 524 and a proximal end 526 relative to the center deck support system 506, whereby the proximal end 526 may define a shipping set point or a wing retraction set point. In one implementation, the distal end 524 of the guide 522 may be proximate the distal end 516 of the mount 514, and the proximal end 526 of the guide 522 may be between the distal and proximal ends 516, 518 of the mount 514. In another implementation, the guide 522 may be sized and shaped such that the distal end 524 of the guide 522 is positioned at a height greater than the proximal end 526 of the guide 522 relative to the top 504 of the cutting deck 502. For example, the guide 522 may be a slant, an arc, substantially horizontal, etc.

The bracket stop 530 may be configured to limit the travel of the center deck support system 506 past a predetermined position. In one implementation, the bracket stop 530 may comprise a comprise a first portion 532 and a second portion 534. In one implementation, the first portion 532 may be pivotably coupled to the proximal end 518 of the mount 514, and the second portion 534 may be pivotably coupled to the bracket 508 of the center deck support system 506. The bracket stop 530 may be further configured such that the first portion 532 may be selectably engaged with the second portion 534.

For example, in one implementation, the first portion 532 of the bracket stop 530 may be configured to telescopically receive the second portion 534. In another implementation, the bracket stop 530 may be configured such that a fastener 536 may be used to secure the second portion 534 with the first portion 532 so as to prevent retraction and extension of the second portion 534 relative to the first portion 532. In another implementation, the bracket stop 530 may be configured such that the fastener 536 may be used as a stopper to prevent retraction of the second portion 534 into and/or toward the first portion 532. In a further implementation, the fastener 536 may be configured to enable the bracket stop 530 to be changed between a first unlocked configuration and a second locked configuration. It will be appreciated that the first and second portions 532, 534 may be any size and shape to enable the bracket stop 530 to have an adjustable length, for example, overlapping beams, circular tubular members, rectangular tubular members, etc. It will also be appreciated that the fastener 536 may be any fastener capable of selectively engaging the first portion 532 with the second portion 534 including, for example, a clevis pin and a cotter pin, a bolt and a nut, a lock pin, a hitch pin, etc.

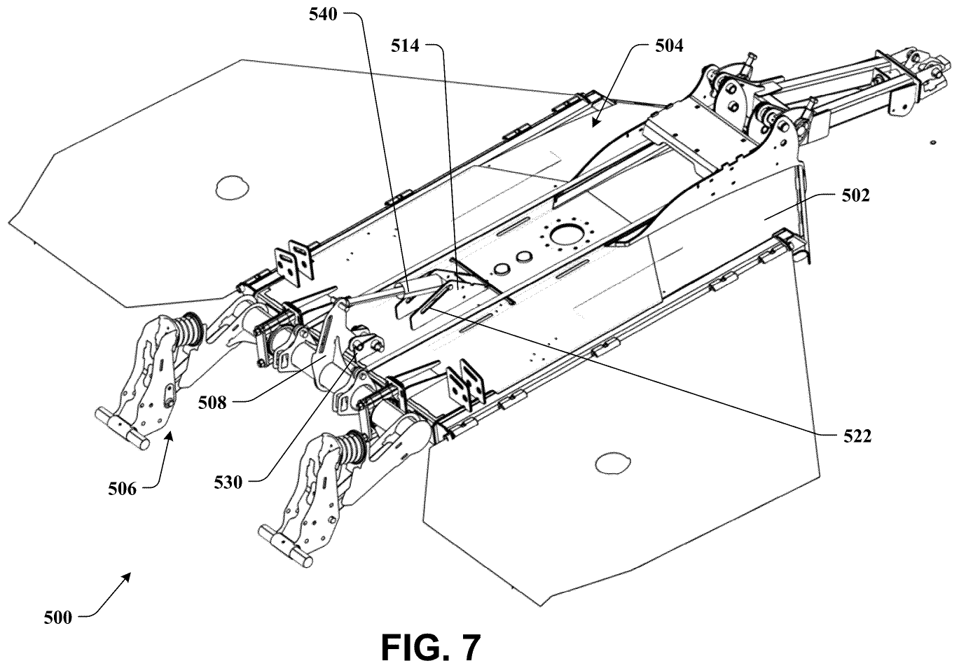

In yet another implementation, as shown in FIG. 7, the first portion 532 of the bracket stop 530 may be fixedly engaged with the top 504 of the cutting deck 502. The second portion 534 of the bracket stop 530 may be pivotably coupled to the second portion 532 and configured to selectably engage the bracket 508 at an end of the second portion 534 opposite the first portion 532 by a bracket pin. The second portion 534 may be configured to pivot between a first unlocked position and a second locked position in relation to the bracket 508. In a first unlocked position, the end of the second portion 534 opposite the first portion 532 of the bracket stop 530 may be pivoted away from the center deck support system 506 so as not to impede the rotation of the bracket 508. In a second locked position, the end of the second portion 543 opposite the first portion 532 of the bracket stop 530 may be pivoted toward the center deck support system 506 such that the bracket pin rests on the first portion 532 of the bracket stop 530 and may act as a stop to the bracket 508 as it rotates during operation of the actuator system 120.

In a further configuration, the bracket stop 530 may comprise a body fixedly engaged to the bracket 508 of the center deck support system 506 and may be configured to operably engage with the top 504 of the cutting deck 502 when the center deck support system 506 rotates to a predetermined position thereby limiting the travel of the center deck support system 506 beyond that predetermined position. It will be appreciated that the bracket stop 530 may be any size, shape, or configuration capable of limiting the travel of the center deck support system 506 past a predetermined position.

The actuator 540 of the locking system 500 comprises a distal end 542 and a proximal end 544 relative to the center deck support system 506. In an implementation, the actuator 540 may further comprise a cylinder 546 and a piston rod 548. It will be appreciated that the actuator 540 may be any actuator capable of engaging the center deck support system 506 to raise and lower the wheel system 510 relative to the cutting deck 502, for example, a hydraulic actuator, a pneumatic actuator, an electrical actuator, and an electromechanical actuator.

The distal end 542 of the actuator 540 may be pivotably, slidably engaged with the guide 522 such that the distal end 542 may translate along the length of the guide 522. The proximal end 544 of the actuator 540 may be pivotably engaged with the bracket 508 of the center deck support system 506. In an implementation, the proximal end 544 of the actuator 540 may be pivotably coupled to the bracket 508 such that the actuator 540 is positioned at a height above the bracket stop 530 relative to the top 504 of the cutting deck 502.

The actuator 540 of the locking system 500 may further comprise an actuator fastener 550 sized and shaped to pivotably couple the distal end 542 of the actuator 540 to the guide 522 such that the distal end 542 of the actuator 540 is configured to translate along the length of the guide 522. It will be appreciated that the actuator fastener 550 may be any fastener capable of pivotably coupling the distal end 542 of the actuator 540 to the guide 522 and translating along the length of the guide 522 including, for example, a clevis pin and a cotter pin, a bolt and a nut, a lock pin, a hitch pin, etc.

The locking system 500 of the rotary cutter 100 may be configured to at least define a minimum height of the cutting deck 502 in relation to the surface beneath the cutting deck 502 when the rotary cutter 100 is being prepared for or in the process of being transported. For example, in one implementation, the locking system 500 may be configured to at least define a minimum height of the center portion 200 in relation to the surface beneath the center portion 200 while the first and second wings 300, 400 are in a first upright position. The locking system 500 may be further configured to enable the deck support systems 306, 406 of the first and second wings 300, 400 to fold inward while maintaining the minimum height of the center portion 200 or cutting deck 502.

In an implementation, the locking system 500 may enable the deck support systems 306, 406 of the first and second wings 300, 400 to fold inward while maintaining the minimum height of the center portion 200 of the cutting deck 502 by selectably engaging the bracket stop 530, and translating the distal end 542 of the actuator 540 of the locking system 500 along the length of the guide 522 as the actuator 540 retracts according to the actuator system 120. For example, the bracket stop 530 may be engaged by selectably engaging a first portion 532 of the bracket stop 530 with a second portion 534. As the piston rod 548 of the actuator 540 retracts into the cylinder 546, the distance between the distal end 542 of the actuator 540 and the bracket 508 of the center deck support system 506 may decrease. In an implementation, because the bracket stop 530 is selectably engaged and coupled between the bracket 508 and the mount 514 at a height less than a height of the actuator 540 relative to the top 504 of the cutting deck 502, the bracket stop 530 may act as a brace or stop to prevent further counterclockwise rotation of the center deck support system 506. Thus, a minimum cutting deck height relative to the surface beneath the cutting deck 502 may be defined at a predetermined position of the bracket 508 based on a size of the bracket stop 530 resulting from the selective engagement of the first portion 532 of the bracket stop 530 to the second portion 534.

Once the actuator 540 retracts to an intermediate position between fully extended and fully retracted at which the center deck support system 506 reaches the predetermined position and is braced or stopped from rotating counterclockwise by the bracket stop 530, the actuator 540 of the locking system 500 may continue to retract by translating the distal end 542 of the actuator 540 along the length of the guide 522. For example, in an implementation, when the first portion 532 is selectably engaged with the second portion 534 of the bracket stop 530 to define a minimum cutting deck height, the distal end 542 of the actuator 540 may translate along the length of the guide 522 while the actuator 540 extends/retracts in a range of being fully retracted to the intermediate position. Conversely, the distal end 542 of the actuator 540 may be pivotably positioned at a distal end 524 of the guide 522, and the center deck support system 506 may rotate when the first portion 532 of the bracket stop 530 is selectably engaged with the second portion 534, and the actuator 540 extends/retracts in a range of being fully extended to the intermediate position. In an implementation, the actuator 540 may be extended/retracted to the intermediate position when the actuator 540 extends/retracts to being about two-thirds extended. It will be appreciated that the intermediate position may be any amount of extension/retraction defining a transition point at which the extension/retraction of the actuator 540 transitions from rotating the center deck support system 506 to causing the distal end 542 of the actuator 540 to translate along the guide 522, for example, one-fourth extended, one-third extended, one-half extended, two-thirds extended, three-fourths extended, etc.

By enabling the actuator 540 of the locking system 500 to continue to retract after the center deck support system 506 stops rotating, the deck support systems of related cutting portions either lacking a locking system or otherwise not having an equivalent selectively engaged bracket stop may continue to rotate. For example, in an implementation, a rotary cutter 100 may comprise a cutting deck 502 comprising a center portion 200 having a locking system 500, and comprising first and second wings 300, 400 each lacking a locking system 500. The center portion 200, first wing 300, and second wing 400 may comprise an actuator system 120 that simultaneously engages actuators 540, 324, 424 of leveling sub-systems to rotate respective deck support systems 506, 306, 406. To enable safe transport of the rotary cutter 100, the first and second wings 300, 400 may be pivoted into a first upright position, thereby narrowing the overall width of the rotary cutter 100. To further narrow the width of the rotary cutter 100, the actuator system 120 may be engaged to rotate the deck support systems 506, 306, 406 counterclockwise, thereby tucking respective wheel systems inward. By selectably engaging a bracket stop 530 to limit the rotation of the center deck support system 506 beyond a predetermined position, and by slidably engaging a distal end 542 of the actuator 540 of the center portion 200 with a guide 522, the center portion 200 may maintain a safe minimum height above a surface for travel while allowing the actuator 540 of the locking system 500 to continue to retract with the actuators 324, 424 of the first and second wings 300, 400 according the actuator system 120.

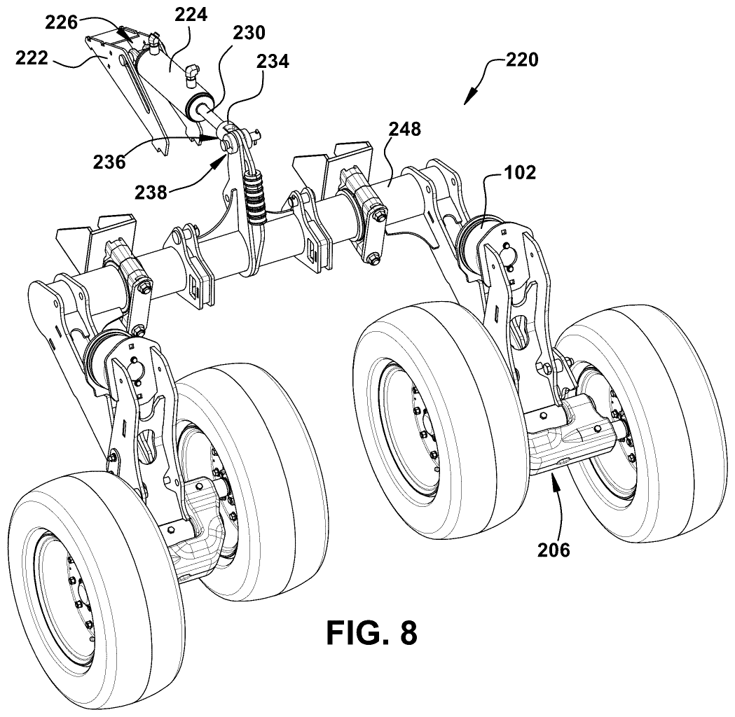

Turning additionally to FIGS. 8-15, a leveling sub-system may be described herein. In addition to moving relative to the center portion 200, the first wing 300 and second wing 400 are configured to have a secondary adjustment, such as to move independently from the center portion 200 and the opposite wing. To enable the secondary adjustment of each of the first wing 300 and second wing 400, the first wing and second wing leveling sub-systems 320, 420 can be used to help further align/level the first wing 300 and the second wing 400 with respect to the center portion 200. By enabling each wing 300, 400 to be further aligned/leveled with respect to the center portion 200, a user can attempt to provide a level cut when using the rotary cutter 100.

The first wing leveling sub-system 320 is further configured to operably adjust the height of the first wing 300 using the independent, secondary adjustment from the center portion 200 and the second wing 400. The piston rod 330 of the first wing leveling sub-system 320 may include a tool surface 360 to accept a tool for rotation and a fastener 362 positioned on the piston rod 330 between the first end 326 of the actuator 324 and clevis 334. In an implementation, the fastener 362 may be configured to be threadably coupled to the piston rod 330 such that the fastener 362 may be moved along at least a portion of a length of the piston rod 330. The fastener 362 is configured such that when the fastener 362 is positioned to abut the clevis 334, the portion of the piston rod 330 received by the clevis 334 is operably, fixedly secured within the clevis 334 to mitigate rotation of the rod 330 during use. The fastener 362 may be any suitable fastener capable of being threadably coupled to a threaded rod, for example, a nut, a jam nut, a stop nut, etc.

The second wing leveling sub-system 420 is further configured to operably adjust the height of the second wing 400 using the independent, secondary adjustment from the center portion 200 and the first wing 300. The piston rod 430 of the second wing leveling sub-system 420 may include a tool surface 460 to accept a tool for rotation and a fastener 462 positioned on the piston rod 430 between the first end 426 of the actuator 424 and clevis 434. In an implementation, the fastener 462 may be threadedly coupled to the piston rod 430 such that the fastener 462 may be moved along at least a portion of a length of the piston rod 430. The fastener 462 is configured such that when the fastener 462 is positioned to abut the clevis 434, the portion of the piston rod 430 threadably received by the clevis 434 is operably, fixedly secured within the clevis 434 to mitigate rotation of the rod 430 during use. The fastener 462 may be any suitable fastener capable of being threadably coupled to a threaded rod, for example, a nut, a jam nut, a stop nut, etc.

To operably adjust the height of the first wing 300 independent from the center portion 200 and the second wing 400, a user may adjust the distance between the first end 326 of the actuator 324 and the clevis 334 of the first wing sub-leveling system 320 by adjusting the length of the piston rod 330 threadably received by the clevis 334. First, a user may rotate the fastener 362 such that the fastener 362 is threadably translated away from the clevis 334 to allow the piston rod 330 to be rotated relative to the clevis 334. The user may then rotate the piston rod 330 with a tool via the tool surface 360, thereby causing the piston rod 330 to threadably translate further into or out of the first end 336 of the clevis 334 without adjusting the position of the piston rod 330 within the actuator 324.

Similar to the actuation of the actuator 324 of the first wing leveling sub-system 320, adjusting the distance between the first end 326 of the actuator 324 and the clevis 334 displaces the deck support system 306 of the first wing 300. As explained above, displacing the deck support system 306 causes the deck support system 306 to rotate about a fulcrum 348, thereby adjusting the height of the first wing 300 with respect to the surface. In an implementation, threadably translating the piston rod 330 away from the clevis 334 increases the distance between the first end 326 of the actuator 324 and the clevis 334, causing the deck support system 306 to rotate clockwise, thereby raising the first wing 300 away from the surface. Inversely, threadably translating the piston rod 330 toward the clevis 334 decreases the distance between the first end 326 of the actuator 324 and the clevis 334, causing the deck support system 306 to rotate counterclockwise, thereby lowering the first wing 300 toward the surface. After the first wing 300 is positioned at a desired height, a user may rotate the fastener 362 to abut the clevis 334 and secure the position of the piston rod 330 in relation to the clevis 334. It will be appreciated that a user may first translate the fastener 362 away from the clevis 334 to enable the rotation of the piston rod 330 in relation to the clevis 334.

To operably adjust the height of the second wing 400 independent from the center portion 200 and the first wing 300, a user may adjust the distance between the first end 426 of the actuator 424 and the clevis 434 of the second wing sub-leveling system 420 by adjusting the length of the piston rod 430 threadably received by the clevis 434. First, a user may rotate the fastener 462 such that the fastener 462 is threadably translated away from the clevis 434 to allow the piston rod 430 to be rotated relative to the clevis 434. The user may then rotate the piston rod 430 with a tool via the tool surface 460, thereby causing the piston rod 430 to threadably translate further into or out of the first end 436 of the clevis 434 without adjusting the position of the piston rod 430 within the actuator 424.

Similar to the actuation of the actuator 424 of the second wing leveling sub-system 420, adjusting the distance between the first end 426 of the actuator 424 and the clevis 434 displaces the deck support system 406 of the second wing 400. As explained above, displacing the deck support system 406 causes the deck support system 406 to rotate about a fulcrum 448, thereby adjusting the height of the second wing 400 with respect to the surface. In an implementation, threadably translating the piston rod 430 away from the clevis 434 increases the distance between the first end 426 of the actuator 424 and the clevis 434, causing the deck support system 406 to rotate clockwise, thereby raising the second wing 400 away from the surface. Inversely, threadably translating the piston rod 430 toward the clevis 434 decreases the distance between the first end 426 of the actuator 424 and the clevis 434, causing the deck support system 406 to rotate counterclockwise, thereby lowering the second wing 400 toward the surface. After the second wing 400 is positioned at a desired height, a user may rotate the fastener 462 to abut the clevis 434 and secure the position of the piston rod 430 in relation to the clevis 434. It will be appreciated that a user may first translate the fastener 462 away from the clevis 434 to enable the rotation of the piston rod 430 in relation to the clevis 434.

The first wing leveling sub-system 320 may be positioned on a top 312 of the first wing 300 proximate a first side 308 of the first wing 300. By positioning the first wing leveling sub-system 320 on the top 312 of the first wing 300 proximate the first side 308, the tool surface 360 and fastener 362 of the first wing leveling sub-system 320 are easily accessible to a user. The first wing leveling sub-system 320 being easily accessible to a user allows for easy leveling of the first wing 300, such as by allowing easier access for use of tools with the sub-system 320, where needed.

The second wing leveling sub-system 420 may be positioned on a top 412 of the second wing 400 proximate a first side 408 of the second wing 400. By positioning the second wing leveling sub-system 420 on the top 412 of the second wing 400 proximate the first side 408, the tool surface 460 and fastener 462 of the second wing leveling sub-system 420 are easily accessible to a user. The second wing leveling sub-system 420 being easily accessible to a user allows for easy leveling of the second wing 400, such as by allowing easier access for use of tools with the sub-system 420, where needed.

While various spatial and directional terms, including but not limited to top, bottom, lower, mid, lateral, horizontal, vertical, front and the like are used to describe the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Of course, those skilled in the art will recognize many modifications may be made to this configuration without departing from the scope or spirit of the claimed subject matter.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

Various operations of implementations are provided herein. In one implementation, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each implementation provided herein.

Any range or value given herein can be extended or altered without losing the effect sought, as will be apparent to the skilled person.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

As used in this application, the terms “component,” “module,” “system,” “interface,” and the like are generally intended to refer to a computer-related entity, either hardware, a combination of hardware and software, software, or software in execution. For example, a component may be, but is not limited to being, a process running on a processor, a processor, an object, an executable, a thread of execution, a program and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device, carrier or media. Of course, those skilled in the art will recognize many modifications may be made to this configuration without departing from the scope or spirit of the claimed subject matter.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed is:

1. A locking system for a rotary cutter, the rotary cutter comprising:
a cutting deck comprising a center portion, a first wing, and a second wing;
a center deck support system pivotably engaged with the cutting deck and comprising a bracket, and a wheel system operably engaging with a surface beneath the cutting deck, and the deck support system being configured to raise and lower the wheel system relative to the cutting deck;
a mount fixedly engaged to the center portion and comprising a guide;
an actuator comprising a distal end slidably engaged with the guide, and proximal end engaged with the bracket; and
a bracket stop limiting the travel of the deck support system past a predetermined position and allowing the distal end of the actuator to move to a shipping set point at the end of the guide whereby putting the first wing and the second wing in position for transport.

2. The locking system according to claim 1, wherein engaging the bracket stop with the bracket and adjusting the extension of the actuator enables the distal end of the actuator to translate along a length of the guide.

3. The locking system according to claim 2, wherein the distal end of the actuator translates along the length of the guide while the actuator is extended in a range of being fully retracted to an intermediate position between fully extended and fully retracted.

4. The locking system according to claim 3, wherein adjusting the extension of the actuator results in an adjustment to a height of the cutting deck relative to the surface while the actuator is extended in a range of being fully extended to the intermediate position.

5. The locking system according to claim 1, wherein disengaging the bracket stop from the bracket and adjusting the extension of the actuator results in an adjustment to a height of the cutting deck relative to the surface.

6. The locking system according to claim 1, wherein the bracket stop comprises a first portion and a second portion, the first portion selectably engaged with the second portion.

7. The locking system according to claim 6, wherein the first portion of the bracket stop is telescopically engaged with the second portion.

8. The locking system according to claim 7 further comprising a fastener sized and shaped to selectably engage the first portion of the body of the bracket stop with the second portion to limit the retraction of the second portion relative to the first portion.

9. The locking system according to claim 6, wherein the second portion of the bracket stop is configured to pivot between a first unlocked position and a second locked position relative to the first portion such that the bracket and the second portion are mitigated from rotation beyond the predetermined position when the second portion is in the second locked position.

10. The locking system according to claim 1, wherein the proximal end of the actuator is engaged with the bracket of the deck support system at a first height, and the bracket stop is selectably engaged with the bracket at a second height, the first height being greater than the second height relative to the cutting deck.

11. The locking system according to claim 1, wherein the guide is a slotted opening in the mount.

12. The locking system according to claim 1, wherein the guide comprises a distal end and a proximal end, and is angled such that the distal end of the guide is at a height relative to the cutting deck greater than a height of the proximal end of the guide.

13. The locking system according to claim 1, wherein the guide is sized and shaped to be one of:
an arc;
a slant; or
substantially horizontal.

14. The locking system according to claim 1, further comprising an actuator fastener sized and shaped to pivotably couple the distal end of the actuator to the guide such that the distal end of the actuator is configured to translate along the length of the guide.

15. The locking system according to claim 1, wherein the deck support system further comprises a fulcrum pivotably engaged with the cutting deck and defining an axis about which the deck support system rotates.

16. A wheel pivot system for a rotary cutter, the rotary cutter comprising:
a cutting deck comprising a center portion, a first wing, and a second wing;
a center deck support system comprising a fulcrum, a bracket, and a wheel system, the fulcrum being coupled to the cutting deck and defining an axis about which the deck support system rotates;
a mount fixedly engaged to the center portion and comprising a guide;
an actuator comprising a distal end that operably engages the bracket of the deck support system such that an activation of the actuator rotates the deck support system, and a proximal end that is slidably engaged with the guide; and
a bracket stop configured to be operably adjustable between a first unlocked configuration and a second locked configuration, the second locked configuration defining a rotation limit of the deck support system,
wherein adjusting the bracket stop to the second locked configuration and activating the actuator to rotate the deck support system limits the travel of the deck support system past a predetermined position and allows the distal end of the actuator to move to a wing retraction set point at the end of the guide whereby putting the first wing and the second wing in position for transport.

17. The wheel pivot system according to claim 16, wherein the distal end of the actuator translates along a length of the guide while the actuator is extended in a range of being fully retracted to an intermediate position between fully extended and fully retracted.

18. The wheel pivot system according to claim 17, wherein adjusting the extension of the actuator results in an adjustment to the height of the cutting deck relative to a surface beneath the cutting deck while the actuator is extended in a range of being fully extended to the intermediate position, the intermediate position being about two-thirds extended.

19. The wheel pivot system according to claim 16, wherein a lower height of the cutting deck relative to a surface beneath the cutting deck while the bracket stop is in the second locked configuration is determined based on a shorter length of the bracket stop in the second locked configuration.

20. A locking system for a rotary cutter, the rotary cutter comprising:
a cutting deck comprising a center portion, a first wing, and a second wing;
the center portion comprising:
a deck support system pivotably engaged with the cutting deck and comprising a bracket, and a wheel system operably engaging with a surface beneath the cutting deck, and the deck support system being configured to raise and lower the wheel system relative to the cutting deck;
a mount fixedly engaged to the center portion and comprising a guide;
an actuator comprising a distal end slidably engaged with the guide, and a proximal end engaged with the bracket; and
bracket stop limiting the travel of the deck support system past a predetermined position and allowing the distal end of the actuator to move to a wing retraction set point at the end of the guide;
the first cutting wing pivotally coupled to the cutting deck, and comprising a first wing support system comprising a wheel system operably engaging with the surface, the first cutting wing further comprising a first wing actuator, the first wing actuator configured to operably engage the first wing support system to extend and retract the wheel system relative to the first cutting wing; and
a second cutting wing pivotally coupled to the cutting deck, and comprising a second wing support system comprising a wheel system operably engaging with the surface, the second cutting wing further comprising a second wing actuator, the second wing actuator configured to operably engage the second wing support system to extend and retract the wheel system relative to the second cutting wing;
wherein the extension of the actuator of the cutting deck, the first wing actuator, and the second wing actuator are configured to be adjusted simultaneously, and wherein the first wing wheel system and second wing wheel system are configured to continue pivoting to a position for transport when the deck support system is limited at the predetermined position.
